(19) United States
(12) Patent Application Publication
(10) Pub. No.: US 2026/0018786 A1
(43) Pub. Date: Jan. 15, 2026

(54) WEARABLE DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/226,513

(22) Filed: Jun. 3, 2025

Related U.S. Application Data
(60) Provisional application No. 63/669,359, filed on Jul. 10, 2024.

(30) Foreign Application Priority Data
May 14, 2025 (TW) 114117992

(51) Int. Cl. H01Q 3/34; H01Q 5/307

(52) U.S. Cl. CPC H01Q 3/34; H01Q 5/307

(57) ABSTRACT

A wearable device includes a first antenna element, a second antenna element, a third antenna element, a first phase shifter, a second phase shifter, a third phase shifter, a signal combiner, and a carrier element. The first antenna element receives a first wireless signal. The second antenna element receives a second wireless signal. The third antenna element receives a third wireless signal. The first phase shifter provides a first compensation phase for the first wireless signal. The second phase shifter provides a second compensation phase for the second wireless signal. The third phase shifter provides a third compensation phase for the third wireless signal. The signal combiner generates an integrated signal according to the first wireless signal, the second wireless signal, and the third wireless signal. The first antenna element, the second antenna element, and the third antenna element are arranged along different directions.

### CROSS REFERENCE TO RELATED APPLICATIONS

This application claims the benefit of U.S. Provisional Application No. 63/669,359, filed on Jul. 10, 2024, and also claims priority of Taiwan Patent Application No. 114117992, filed on May 14, 2025, the entirety of which are incorporated by reference herein.

### BACKGROUND OF THE INVENTION

### Field of the Invention

The invention relates to a wearable device, and more particularly, it relates to a wearable device and a communication method thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHZ, 850 MHz, 900 MHz, 1800 MHZ, 1900 MHZ, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements in the field of wireless communication. If polarization directions of antennas are too limited, they may tend to increase the communication loss of the relative mobile device. Accordingly, there is a need to propose a novel solution for solving the problem of the prior art.

### BRIEF SUMMARY OF THE INVENTION

In an exemplary embodiment, the invention is directed to a wearable device that includes a first antenna element, a second antenna element, a third antenna element, a first phase shifter, a second phase shifter, a third phase shifter, a signal combiner, and a carrier element. The first antenna element receives a first wireless signal. The second antenna element receives a second wireless signal. The third antenna element receives a third wireless signal. The first phase shifter is coupled to the first antenna element. The first phase shifter provides a first compensation phase for the first wireless signal. The second phase shifter is coupled to the second antenna element. The second phase shifter provides a second compensation phase for the second wireless signal. The third phase shifter is coupled to the third antenna element. The third phase shifter provides a third compensation phase for the third wireless signal. The signal combiner is coupled to the first phase shifter, the second phase shifter, and the third phase shifter. The signal combiner generates an integrated signal according to the first wireless signal, the second wireless signal, and the third wireless signal. The first antenna element, the second antenna element, and the third antenna element are all disposed on the carrier element, and they are arranged along different directions.

In some embodiments, each of the first wireless signal, the second wireless signal, and the third wireless signal is a satellite communication signal.

In some embodiments, the wearable device is a pair of smart eyeglasses with a function of wireless communication.

In some embodiments, the carrier element includes a frame element and an extension element. The extension element is connected to the frame element.

In some embodiments, the frame element is a glasses frame.

In some embodiments, the extension element is a temple.

In some embodiments, the first antenna element is disposed on the extension element.

In some embodiments, the second antenna element and the third antenna element are disposed on different positions of the frame element.

In some embodiments, the first antenna element, the second antenna element, and the third antenna element are substantially perpendicular to each other.

In some embodiments, each of the first antenna element, the second antenna element, and the third antenna element is a linearly-polarized antenna.

In some embodiments, the wearable device further includes a control circuit for generating a control signal. The first compensation phase, the second compensation phase, and the third compensation phase are determined according to the control signal.

In some embodiments, the control circuit includes an IMU (Inertial Measurement Unit).

In some embodiments, the control circuit includes a GPS (Global Positioning System) module.

In some embodiments, a first phase difference between the first compensation phase and the second compensation phase is substantially equal to 90 degrees.

In some embodiments, a second phase difference between the second compensation phase and the third compensation phase is substantially equal to 90 degrees.

In another exemplary embodiment, the invention is directed to a communication method that includes the steps of: providing a carrier element, a first antenna element, a second antenna element, and a third antenna element, wherein the first antenna element, the second antenna element, and the third antenna element are disposed on the carrier element and are arranged along different directions; receiving a first wireless signal by a first antenna element; receiving a second wireless signal by a second antenna element; receiving a third wireless signal by a third antenna element; providing a first compensation phase for the first wireless signal; providing a second compensation phase for the second wireless signal; providing a third compensation phase for the third wireless signal; and generating an integrated signal according to the first wireless signal, the second wireless signal, and the third wireless signal.

### BRIEF DESCRIPTION OF DRAWINGS

The invention can be more fully understood by reading the subsequent detailed description and examples with references made to the accompanying drawings, wherein:

FIG. 1 is a diagram of a wearable device according to an embodiment of the invention;

FIG. 2A is a perspective view of a wearable device according to an embodiment of the invention;

FIG. 2B is a perspective view of a wearable device according to another embodiment of the invention

FIG. 3 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

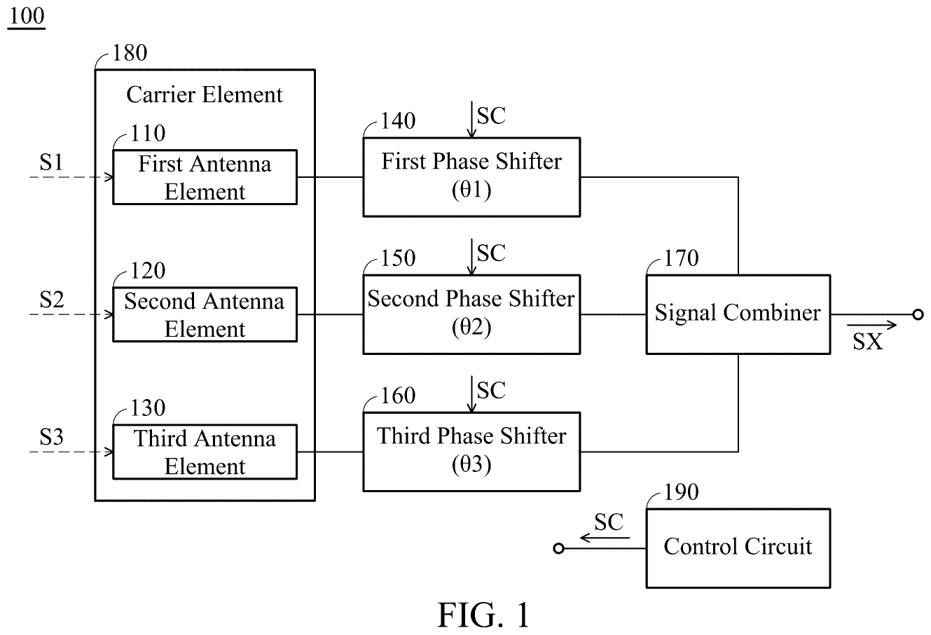

FIG. 1 is a diagram of a wearable device 100 according to an embodiment of the invention. For example, the wearable device 100 may be applied to the field of VR (Virtual Reality) or AR (Augmented Reality), but it is not limited thereto. In the embodiment of FIG. 1, the wearable device 100 at least includes a first antenna element 110, a second antenna element 120, a third antenna element 130, a first phase shifter 140, a second phase shifter 150, a third phase shifter 160, a signal combiner 170, and a carrier element 180. The first antenna element 110, the second antenna element 120, and the third antenna element 130 may all be made of metal materials, such as copper, silver, aluminum, iron, or their alloys. It should be understood that the wearable device 100 may further include other components, such as a transmission line, a signal source, an electrode, a battery, and/or a power supply module, although they are not displayed in FIG. 1.

The shapes and types of the first antenna element 110, the second antenna element 120, and the third antenna element 130 are not limited in the invention. For example, each of the first antenna element 110, the second antenna element 120, and the third antenna element 130 may be a monopole antenna, a dipole antenna, a patch antenna, or a chip antenna.

The first antenna element 110 can receive a first wireless signal S1. The first phase shifter 140 is coupled to the first antenna element 110. The first phase shifter 140 can provide a first compensation phase θ1 for the first wireless signal S1.

The second antenna element 120 can receive a second wireless signal S2. The second phase shifter 150 is coupled to the second antenna element 120. The second phase shifter 150 can provide a second compensation phase θ2 for the second wireless signal S2. For example, a first phase difference between the first compensation phase θ1 and the second compensation phase θ2 may be substantially equal to 90 degrees, but it is not limited thereto.

The third antenna element 130 can receive a third wireless signal S3. The third phase shifter 160 is coupled to the third antenna element 130. The third phase shifter 160 can provide a third compensation phase θ3 for the third wireless signal S3. For example, a second phase difference between the second compensation phase θ2 and the third compensation phase θ3 may be substantially equal to 90 degrees, but it is not limited thereto.

In some embodiments, the first compensation phase θ1 is substantially equal to 0 degrees, the second compensation phase θ2 is substantially equal to 90 degrees, and the third compensation phase θ3 is substantially equal to 180 degrees. In alternative embodiments, the first compensation phase θ1 is substantially equal to 180 degrees, the second compensation phase θ2 is substantially equal to 90 degrees, and the third compensation phase θ3 is substantially equal to 0 degrees.

In some embodiments, each of the first wireless signal S1, the second wireless signal S2, and the third wireless signal S3 is a satellite communication signal. For example, the first antenna element 110, the second antenna element 120, and the third antenna element 130 may cover an operational frequency band, which may be from 1 GHz to 30 GHz. In alternative embodiments, the wearable device 100 can support NTN (Non-Terrestrial Network) frequency intervals, such as an L-band (n225), an S-band (s256), etc.

The signal combiner 170 is coupled through the first phase shifter 140 to the first antenna element 110. The signal combiner 170 is also coupled through the second phase shifter 150 to the second antenna element 120. The signal combiner 170 is further coupled through the third phase shifter 160 to the third antenna element 130. In addition, the signal combiner 170 can generate an integrated signal SX according to the first wireless signal S1, the second wireless signal S2, and the third wireless signal S3. For example, the integrated signal SX may record a variety of information related to the first wireless signal S1, the second wireless signal S2, and the third wireless signal S3.

In some embodiments, the integrated signal SX is generated merely according to any two wireless signals selected among the first wireless signal S1, the second wireless signal S2, and the third wireless signal S3. The selected wireless signal may be considered as two target wireless signals. For example, the target wireless signals may have similar signal strengths, and a phase difference therebetween may be close to 90 degrees. In alternative embodiments, there is a first time slot corresponding to the first wireless signal S1 and the second wireless signal S2, and there is also a second time slot corresponding to the second wireless signal S2 and the third wireless signal S3. The second time slot may follow the first time slot.

The carrier element 180 may be made of a nonconductive material, such as a plastic material. The shapes and types of the carrier element 180 are not limited in the invention. The first antenna element 110, the second antenna element 120, and the third antenna element 130 are all disposed on the carrier element 180. In alternative embodiments, the first phase shifter 140, the second phase shifter 150, the third phase shifter 160, and the signal combiner 170 are also disposed on the carrier element 180, but they are not limited thereto.

In some embodiments, the wearable device 100 further includes a control circuit 190. The control circuit 190 is coupled to the first phase shifter 140, the second phase shifter 150, and the third phase shifter 160. The control circuit 190 can generate a control signal SC. The first compensation phase θ1, the second compensation phase θ2, and the third compensation phase θ3 may be determined according to the control signal SC. It should be understood that the control circuit 190 is merely an operational component, which is omitted in other embodiments.

For example, each of the first antenna element 110, the second antenna element 120, and the third antenna element 130 may be a linearly-polarized antenna. In a preferred embodiment, the first antenna element 110, the second antenna element 120, and the third antenna element 130 are arranged along different directions, such that any combination of the first antenna element 110, the second antenna element 120, and the third antenna element 130 can receive a variety of wireless signals with CP (Circular Polarization) characteristics. Furthermore, the incorporation of the first phase shifter 140, the second phase shifter 150, and the third phase shifter 160 can help to modify the non-ideal characteristics of the first wireless signal S1, the second wireless signal S2, and the third wireless signal S3. According to practical measurements, the proposed wearable device 100 of the invention can significantly reduce the overall reception loss of these wireless signals.

The following embodiments will introduce different configurations and detail structural features of the wearable device 100. It should be understood that these figures and descriptions are merely exemplary, rather than limitations of the invention.

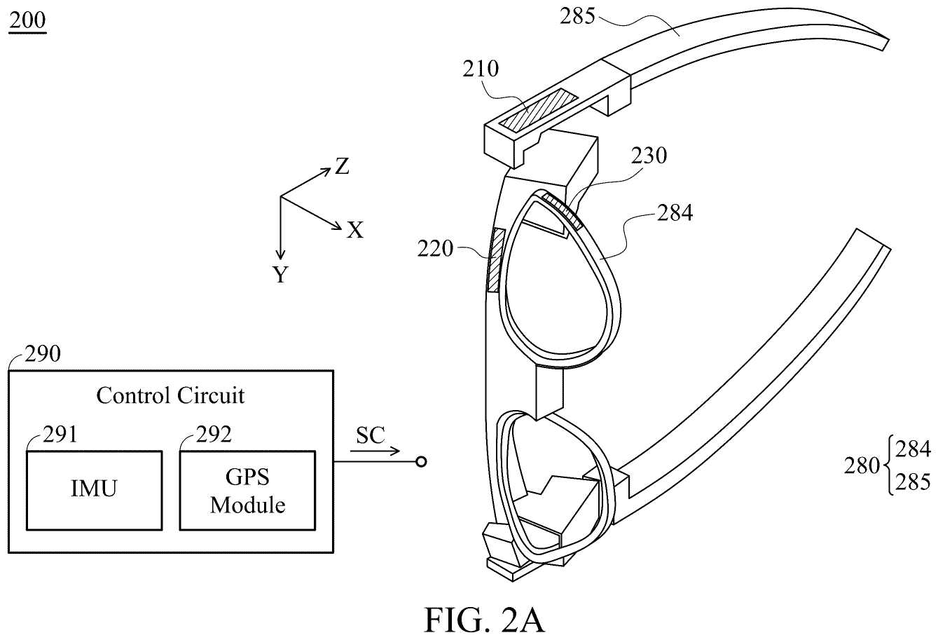

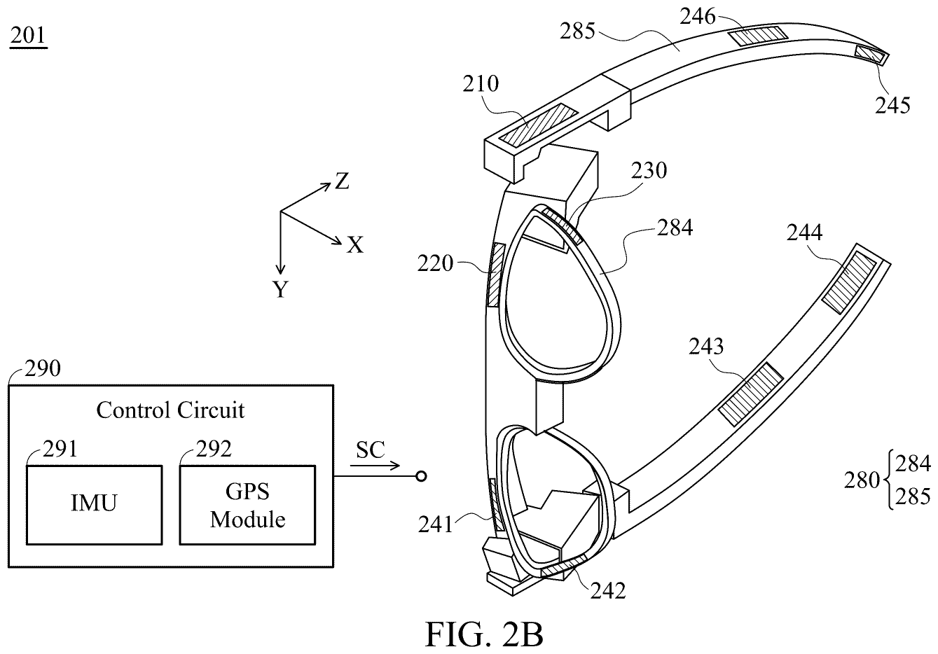

FIG. 2A is a perspective view of a wearable device 200 according to an embodiment of the invention. FIG. 2A is similar to FIG. 1. In the embodiment of FIG. 2A, the wearable device 200 is a pair of smart eyeglasses with the function of wireless communication, and a carrier element 280 of the wearable device 200 includes a frame element 284 and an extension element 285. The extension element 285 is connected to the frame element 284. For example, the frame element 284 may be a glasses frame, and the extension element 285 may be a temple.

Specifically, the wearable device 200 also includes a first antenna element 210, a second antenna element 220, and a third antenna element 230. The first antenna element 210 is disposed on the extension element 285. The second antenna element 220 and the third antenna element 230 are disposed on different positions of the frame element 284. Each of the first antenna element 210, the second antenna element 220, and the third antenna element 230 may be a linearly-polarized antenna. It should be noted that the first antenna element 210, the second antenna element 220, and the third antenna element 230 are substantially perpendicular to each other. For example, the first antenna element 210 may be substantially arranged parallel to the Z-axis, the second antenna element 220 may be substantially arranged parallel to the Y-axis, and the third antenna element 230 may be substantially arranged parallel to the X-axis. According to practical measurements, such an orthogonal antenna arrangement can help to minimize the overall reception loss of a variety of wireless signals with CP characteristics.

In addition, a control circuit 290 of the wearable device 200 may include an IMU (Inertial Measurement Unit) 291 and/or a GPS (Global Positioning System) module 292. For example, the IMU 291 may detect movement information or rotation information of a user, and the GPS module 292 may detect position information of the user. The control circuit 290 can generate a control signal SC based on the detection results of the IMU 291 and/or the GPS module 292 (e.g., the movement information, the rotation information, or the position information as mentioned above). Next, a first phase shifter, a second phase shifter, and a third phase shifter (not shown) of the wearable device 200 can provide a first compensation phase, a second compensation phase, and a third compensation phase according to the control signal SC, respectively. With such a design, the non-ideal characteristics of the corresponding wireless signals of the wearable device 200 can be further suppressed. Other features of the wearable device 200 of FIG. 2A are similar to those of the wearable device 100 of FIG. 1. Thus, the two embodiments can achieve similar levels of performance.

FIG. 2B is a perspective view of a wearable device 201 according to another embodiment of the invention. FIG. 2B is similar to FIG. 2A. In the embodiment of FIG. 2B, the wearable device 201 further includes a first auxiliary antenna element 241, a second auxiliary antenna element 242, a third auxiliary antenna element 243, a fourth auxiliary antenna element 244, a fifth auxiliary antenna element 245, and a sixth auxiliary antenna element 246, which may be disposed on different positions of the frame element 284 and the extension element 285. The first auxiliary antenna element 241, the second auxiliary antenna element 242, the third auxiliary antenna element 243, the fourth auxiliary antenna element 244, the fifth auxiliary antenna element 245, and the sixth auxiliary antenna element 246 can receive a first wireless signal, a second wireless signal, a third wireless signal, a fourth wireless signal, a fifth wireless signal, and a sixth wireless signal, respectively. In addition, an integrated signal of the wearable device 201 may be generated according to any four wireless signals selected among the first wireless signal, the second wireless signal, the third wireless signal, the fourth wireless signal, the fifth wireless signal, and the sixth wireless signal. The selected wireless signals may be considered as four target wireless signals. For example, the target wireless signals may have similar signal strengths, and they may support an OAM (Orbital Angular Momentum) signal mode. Other features of the wearable device 201 of FIG. 2B are similar to those of the wearable device 200 of FIG. 2A. Thus, the two embodiments can achieve similar levels of performance. In some embodiments, the aforementioned OAM signal mode can be described as the following Table I:

TABLE I
OAM Signal Mode

| | Phase Difference Between Adjacent | |
|---|---|---|
| Mode Code | Auxiliary Antenna Element | |
| 0 | 0 | degrees |
| +1 | 90 | degrees |
| +2 | 180 | degrees |
| +3 | 270 | degrees |
| +4 | 360 | degrees |
| −1 | −90 | degrees |
| −2 | −180 | degrees |

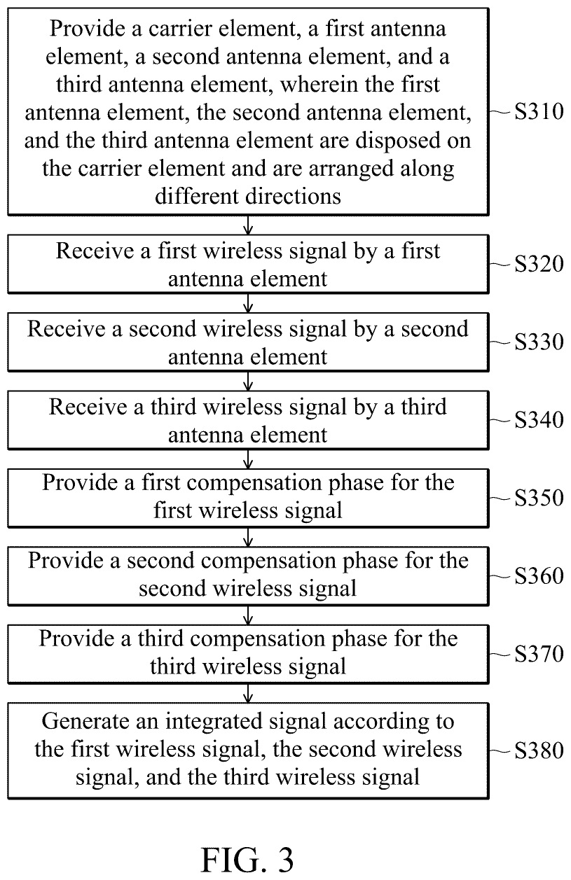

FIG. 3 is a flowchart of a communication method according to an embodiment of the invention. To begin, in step S310, a carrier element, a first antenna element, a second antenna element, and a third antenna element are provided. The first antenna element, the second antenna element, and the third antenna element are disposed on the carrier element, and are arranged along different directions. In step S320, a first wireless signal is received by a first antenna element. In step S330, a second wireless signal is received by a second antenna element. In step S340, a third wireless signal is received by a third antenna element. In step S350, a first compensation phase is provided for the first wireless signal. In step S360, a second compensation phase is provided for the second wireless signal. In step S370, a third compensation phase is provided for the third wireless signal. Finally, in step S380, an integrated signal is generated according to the first wireless signal, the second wireless signal, and the third wireless signal. It should be understood that these steps are not required to be performed in order, and every feature of the embodiments of FIGS. 1, 2A and 2B may be applied to the communication method of FIG. 3.

The invention proposes a novel wearable device. According to practical measurements, the wearable device using the above design can significantly reduce its overall reception loss. Therefore, the invention is suitable for application in a variety of equipment.

Note that the above element parameters are not limitations of the invention. A designer can fine-tune these setting values according to different requirements. It should be understood that the wearable device and the communication method of the invention are not limited to the configurations of FIGS. 1-3. The invention may include any one or more features of any one or more embodiments of FIGS. 1-3. In other words, not all of the features displayed in the figures should be implemented in the wearable device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device, comprising:
a first antenna element, receiving a first wireless signal;
a second antenna element, receiving a second wireless signal;
a third antenna element, receiving a third wireless signal;
a first phase shifter, coupled to the first antenna element, wherein the first phase shifter provides a first compensation phase for the first wireless signal;
a second phase shifter, coupled to the second antenna element, wherein the second phase shifter provides a second compensation phase for the second wireless signal;
a third phase shifter, coupled to the third antenna element, wherein the third phase shifter provides a third compensation phase for the third wireless signal;
a signal combiner, coupled to the first phase shifter, the second phase shifter, and the third phase shifter, wherein the signal combiner generates an integrated signal according to the first wireless signal, the second wireless signal, and the third wireless signal; and
a carrier element, wherein the first antenna element, the second antenna element, and the third antenna element are disposed on the carrier element and are arranged along different directions.

2. The wearable device as claimed in claim 1, wherein each of the first wireless signal, the second wireless signal, and the third wireless signal is a satellite communication signal.

3. The wearable device as claimed in claim 1, wherein the wearable device is a pair of smart eyeglasses with a function of wireless communication.

4. The wearable device as claimed in claim 1, wherein the carrier element comprises a frame element and an extension element, and the extension element is connected to the frame element.

5. The wearable device as claimed in claim 4, wherein the frame element is a glasses frame.

6. The wearable device as claimed in claim 4, wherein the extension element is a temple.

7. The wearable device as claimed in claim 4, wherein the first antenna element is disposed on the extension element.

8. The wearable device as claimed in claim 4, wherein the second antenna element and the third antenna element are disposed on different positions of the frame element.

9. The wearable device as claimed in claim 1, wherein the first antenna element, the second antenna element, and the third antenna element are substantially perpendicular to each other.

10. The wearable device as claimed in claim 1, wherein each of the first antenna element, the second antenna element, and the third antenna element is a linearly-polarized antenna.

11. The wearable device as claimed in claim 1, further comprising:
a control circuit, generating a control signal, wherein the first compensation phase, the second compensation phase, and the third compensation phase are determined according to the control signal.

12. The wearable device as claimed in claim 11, wherein the control circuit comprises an IMU (Inertial Measurement Unit).

13. The wearable device as claimed in claim 11, wherein the control circuit comprises a GPS (Global Positioning System) module.

14. The wearable device as claimed in claim 1, wherein a first phase difference between the first compensation phase and the second compensation phase is substantially equal to 90 degrees.

15. The wearable device as claimed in claim 1, wherein a second phase difference between the second compensation phase and the third compensation phase is substantially equal to 90 degrees.

16. A communication method, comprising the steps of:
providing a carrier element, a first antenna element, a second antenna element, and a third antenna element, wherein the first antenna element, the second antenna element, and the third antenna element are disposed on the carrier element and are arranged along different directions;
receiving a first wireless signal by a first antenna element;
receiving a second wireless signal by a second antenna element;
receiving a third wireless signal by a third antenna element;
providing a first compensation phase for the first wireless signal;
providing a second compensation phase for the second wireless signal;
providing a third compensation phase for the third wireless signal; and
generating an integrated signal according to the first wireless signal, the second wireless signal, and the third wireless signal.

17. The communication method as claimed in claim 16, wherein each of the first wireless signal, the second wireless signal, and the third wireless signal is a satellite communication signal.

18. The communication method as claimed in claim 16, wherein the first antenna element, the second antenna element, and the third antenna element are substantially perpendicular to each other.

19. The communication method as claimed in claim 16, wherein a first phase difference between the first compensation phase and the second compensation phase is substantially equal to 90 degrees.

20. The communication method as claimed in claim 16, wherein a second phase difference between the second compensation phase and the third compensation phase is substantially equal to 90 degrees.
